(19) United States
(12) Patent Application Publication
(10) Pub. No.: US 2007/0208461 A1
(43) Pub. Date: Sep. 6, 2007

(54) HVAC CONTROL WITH PROGRAMMED RUN-TEST SEQUENCE

(75) Inventor: Thomas Dale CHASE, Derby, KS (US)

Correspondence Address: MCNEES WALLACE & NURICK LLC, 100 PINE ST., P.O. BOX 1166, HARRISBURG, PA, 17108-1166, US

(73) Assignee: JOHNSON CONTROLS TECHNOLOGY COMPANY, Holland, MI (US)

(21) Appl. No.: 11/678,172

(22) Filed: Feb. 23, 2007

Related U.S. Application Data
(60) Provisional application No. 60/777,776, filed on Mar. 1, 2006.

(51) Int. Cl. G05D 23/12; G01M 1/38

(52) U.S. Cl. 700/276; 236/1 C

(57) ABSTRACT

An HVAC control system is disclosed that includes an HVAC unit and a control device for controlling operation of the HVAC unit. The control device has a plurality of terminals configured to receive or transmit control signals for the HVAC unit, a memory device storing a run-test initiation code and instructions for executing a run-test sequence and a microprocessor configured to receive a plurality of control signals corresponding to the run-test initiation code at least one terminal of the plurality of terminals. The microprocessor is configured to execute the instructions for executing the run-test sequence in response to receiving the plurality of control signals corresponding to the run-test initiation code.

### CROSS-REFERENCE TO RELATED PATENT APPLICATIONS

This application claims priority to U.S. Provisional Patent Application No. 60/777,776, filed Mar. 1, 2006, the entirety of which is hereby incorporated by reference.

### BACKGROUND

Integrated or combined controls or control systems are common in the heating, ventilating and air conditioning (HVAC) industry. It is common for these types of controls to have a small amount of programmable read-only memory (ROM) which is used to store normal operating sequences for the HVAC unit. For instance, in a furnace, this memory usually contains information on blower timings and ignition timings. The ROM also generally includes information that controls how the HVAC unit behaves in abnormal conditions, to ensure that it always operates in a safe manner. The ROM may also include some type of limited diagnostic capabilities, which typically result as an error code being displayed as a blink code on an LED (light emitting diode), or as a display on a seven segment display, to be used by a repair technician as an aid to determining the source of an operational problem.

During production, HVAC units are typically tested after being assembled. Manufacturers of gas heating furnaces for residential use are required to perform a run test on each unit produced to demonstrate that the furnace operates properly. Run-test information is collected during testing to verify that the unit is operating within normal parameters. The customary way of collecting this data is to use a programmable run-test station located on the factory assembly line. These run-test stations utilize various connections to the furnace and contain a variety of relays or PLCs (programmable logic controllers) whose function is to operate the furnace in its various operating modes in order to collect data at appropriate times during the testing process.

Some existing HVAC controls have an internally-programmed factory speed-up mode in which some or all of the normal timings are sequenced more rapidly to accelerate the test process. But these controls still require an external run-test station that controls the operation of the HVAC unit through its various operating modes. Connecting the unit to the run-test station and conducting the tests is a time-consuming and inefficient process and requires expensive equipment.

Accordingly, what is needed is an HVAC control that contains a run-test sequence procedure programmed in the memory of the HVAC control device.

### SUMMARY

The present application is directed to an HVAC control device having a preprogrammed run-test sequence and a method of using the control device to perform the run-test sequence.

According to one embodiment of the invention, an HVAC control system comprises an HVAC unit and a control device for controlling operation of the HVAC unit. The control device comprises a plurality of terminals configured to receive or transmit control signals for the HVAC unit, a memory device storing a run-test initiation code and instructions for executing a run-test sequence, and a microprocessor configured to receive a plurality of control signals corresponding to the run-test initiation code at at least one terminal of the plurality of terminals and further configured to execute the instructions for executing the run-test sequence in response to receiving the plurality of control signals corresponding to the run-test initiation code.

According to another embodiment of the invention, a method for controlling an HVAC unit having an HVAC control device comprises transmitting control signals to an HVAC control device, comparing the transmitted control signals to a run-test initiation code stored in a memory of the HVAC control device and executing a run-test sequence stored in the memory of the HVAC control device in response to the transmitted control signals matching the run-test initiation code.

An advantage of embodiments described herein is that instead of requiring external timers or PLCs to turn on and off the various functions of the HVAC unit at the correct times so that proper data can be collected, a control device includes a procedure stored in its internal memory to turn on and off the various functions of the unit.

Another advantage of embodiments described herein is that the test data can be collected without requiring the use of expensive external timing equipment.

Still another advantage of embodiments described herein is that because the run-test sequence is programmed in the control itself, the test mode can be initiated at any time or place, even after the unit is installed, should such testing be desirable.

Alternative exemplary embodiments relate to other features and combinations of features as may be generally recited in the claims.

### BRIEF DESCRIPTION OF THE DRAWINGS

The application will become more fully understood from the following detailed description, taken in conjunction with the accompanying figures.

FIG. 1 illustrates an exemplary method of controlling an HVAC system having a pre-programmed run-test sequence.

FIG. 2 illustrates an exemplary run-test sequence.

FIG. 3 illustrates an exemplary testing system.

### DETAILED DESCRIPTION OF THE INVENTION

Before turning to the figures which illustrate the exemplary embodiments in detail, it should be understood that the application is not limited to the details or methodology set forth in the following description or illustrated in the figures. It should also be understood that the phraseology and terminology employed herein is for the purpose of description only and should not be regarded as limiting.

HVAC units, like most products, are typically tested after manufacture. During run testing, operational data values are typically collected from the HVAC unit for comparison to an expected range of values, thereby demonstrating whether the HVAC unit is operating properly.

Embodiments described herein have a control board or other control device with a pre-programmed sequence stored in an internal memory for execution as part of a run-test for an HVAC unit. Instead of requiring external timers or PLCs to turn on and off the various functions of the HVAC unit at the correct times so that proper data can be collected, the control device uses a procedure stored in an internal memory to turn on and off the various functions of the unit.

This provides an advantage over existing technology in that the test data can be collected without requiring the use of expensive external timing equipment. In fact, the test mode can be initiated at any time or place, even when the unit is installed in a home, if such testing should be desired or necessary.

While the HVAC control device referred to herein is discussed with respect to a modulating gas furnace and various terminals typically found thereon, it will be appreciated that this discussion is exemplary only and that the particular procedure discussed in more detail below would equally work for run-test operations of other types of furnaces, as well as air conditioners, heat pumps, or any other HVAC unit desired to be run-tested and which has a control device.

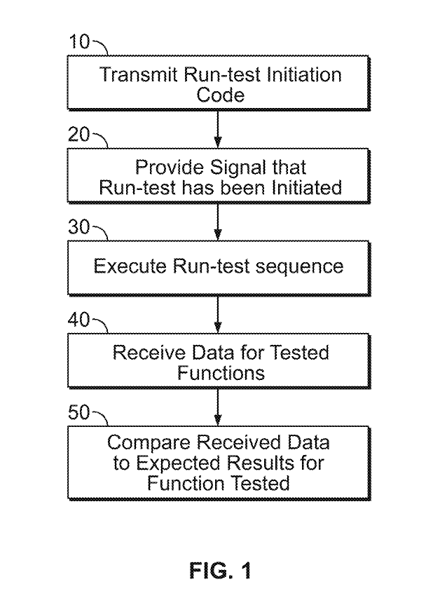

In accordance with an exemplary embodiment, with reference to FIG. 1, a run-test initiation code is transmitted to an HVAC control device to begin the run-test sequence at step 10. Preferably, the control device then provides a signal that the run-test has been initiated at step 20.

A run-test sequence programmed in a memory of the control device is executed by a microprocessor of the control device in step 30, which directs the HVAC unit to perform a pre-determined sequential series of HVAC unit operations. Data, in the form of electronic signals from the HVAC unit, typically measured in watts, amps, or gas flow rates, by way of example only, is received at a data collection station at step 40. The collected data for the various unit operations is compared with expected results for those operations in step 50.

A predetermined run-test initiation code includes a plurality of preselected control signals assigned to an HVAC control device having a memory. By “control signals” is meant any analog or digital signal or combination of analog or digital signals that can be sent to the HVAC control device to provide instructions or other information for the operation of the HVAC unit. The HVAC control device can be a control device for any corresponding HVAC unit including, but not limited to, furnace controls for a furnace, heat pump controls for a heat pump, air handler controls for an air handler, and compressor controls for a compressor, such as used in an air conditioner or heat pump, for example. The HVAC control device's memory can be any suitable electronic storage device as is known in the art and is typically an EEPROM or other non-volatile memory.

The predetermined run-test initiation code used to initiate the run-test sequence can be any desired combination or sequence or timed arrangement of HVAC control signals that, when received by the HVAC control device, initiates the pre-programmed run-test sequence stored in the control device's memory. Although the run-test initiation code and the run-test sequence are programmed in the control device's memory, the control signals that match the run-test initiation code, and thus actually initiate the run test sequence, usually, but not necessarily, come from an external source in communication with the HVAC control device. In one embodiment, these control signals come from the data collection station. Alternatively, for example, a dedicated “test” button to provide the control signals matching the run-test initiation code could be included as part of the control device.

Thus, control signals initiate the run-test sequence in which control signals that match the run-test initiation code cause a certain logic sequence to occur that initiates the run-test sequence. For example, the run-test initiation code may be a series of switches, signals or terminals that are energized or de-energized for a certain period of time. The run-test initiation code is preferably selected such that the particular order and/or combination of control signals would not be received by the HVAC control device under ordinary conditions. In this way, the control signals during normal operation would not inadvertently initiate the test sequence. The run-test initiation code is programmed into the control device when the control device is built, the run-test initiation code being programmed into the memory of the control device.

In one embodiment, terminals on the control device, such as thermostat connections, are connected to the data collection station, which may be, but is not necessarily, external the HVAC unit. An electrical short is applied to a plurality of thermostat connections in the form control signals matching a predetermined run-test initiation code and the power to the HVAC unit is turned on. The control signals to initiate the run-test sequence are typically delivered via the data collection station. The data collection station may also be used to provide power to the HVAC unit during the test. One suitable combination of terminals that may be used for the run-test initiation code in a modulating gas furnace is introducing a short to connections R, W and Y1.

The presence of the R-W-Y1 short serves as a signal to the control device to enter a run-test mode and perform a series of functions according to a sequence programmed into the control device memory. The control device gives a visual signal that it is entering run-test mode, preferably by flashing an LED or other output device mounted on the control board. The visual signal may remain present for the duration of the run test sequence. Once the run-test initiation code has been entered and the run sequence is ready to begin, the R-W-Y1 short is removed so that control signals used for the preprogrammed run-test sequence are not impeded. The control device energizes the control terminals according to the programmed run-test sequence to operate the furnace in various modes for pre-determined amounts of time. During this time, test data is collected at the data collection station for each of the various modes or functions that make up the run-test. The collected data can be compared against expected values to determine whether or not the run-test was successful and if the HVAC unit is ready for delivery and installation.

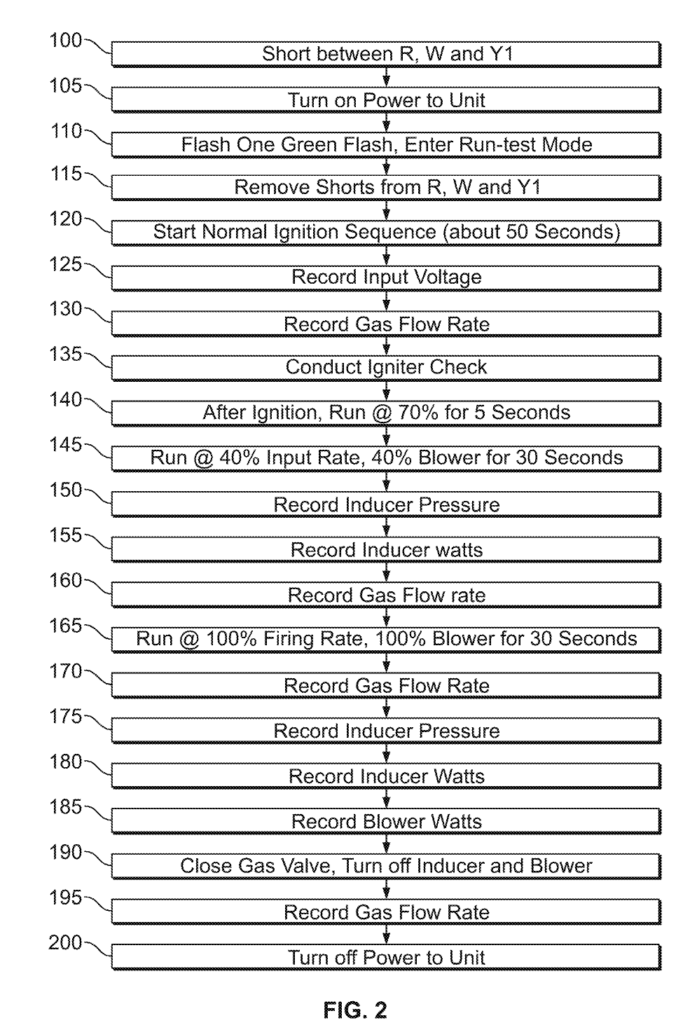

An exemplary run-test sequence for testing a gas modulation furnace is shown in FIG. 2. A short is introduced into the R, W and Y1 terminals, 100, that provides control signals that match the run-test initiation code when the power is turned on, 105. Following a signal to indicate that the run-test mode has been entered, 110, the shorts are removed, 115, and a normal ignition sequence is started, 120. Various properties relating to the ignition sequence are monitored and/or recorded at the data collection station, such as the flow rate of a fuel gas introduced into the furnace via a gas valve, 125 to 135. Next, the furnace is run at several different heat output rates and/or different blower speeds, 140 to 160, while additional properties useful in determining proper operation are monitored and/or recorded. Finally, the furnace is operated for a period of time at its maximum heat output and blower speeds, while still more data is collected, 165 to 185, before closing the gas valve and eventually powering the unit down at the conclusion of the run-test sequence, 190 to 200.

Although certain functions are illustrated here and/or are described as being performed in a certain order, it will be appreciated that the run-test sequence may include any functions desired to be tested and that the functions may occur in any order. Likewise, the properties transmitted to the data collection station may also be recorded, analyzed or compared in any order.

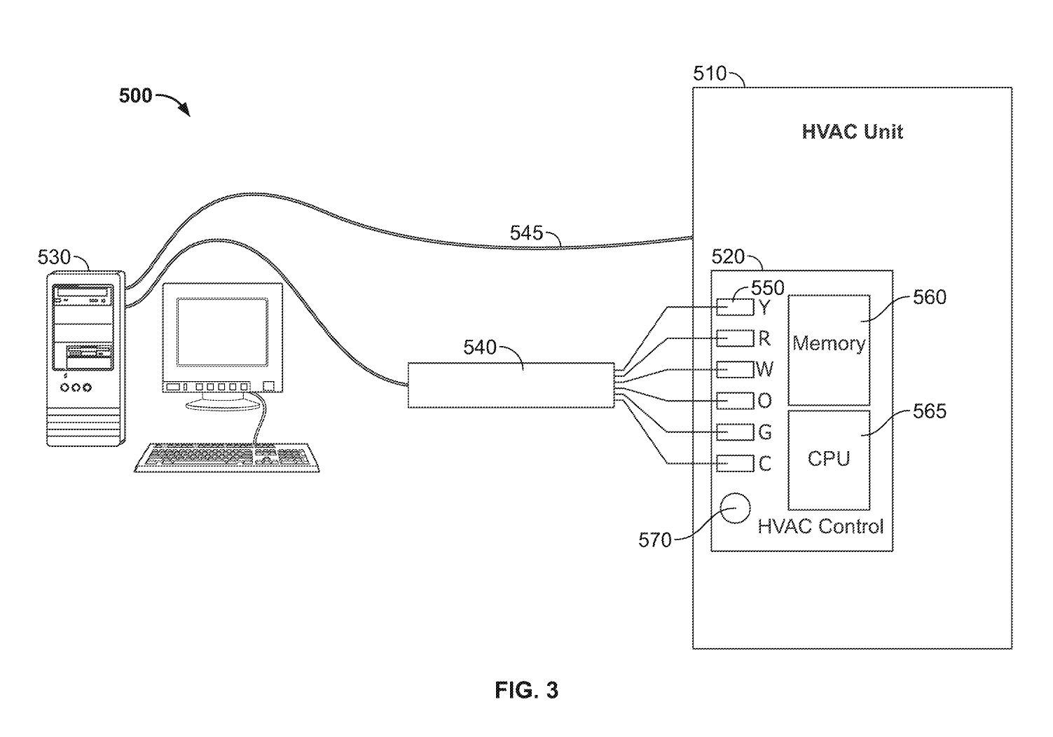

FIG. 3 shows an exemplary testing arrangement 500. An HVAC unit 510 having an HVAC control device 520 is in communication with an external data collection station 530, such as via a plurality of wires (wire bundle 540) attached to terminals 550 of the HVAC control device 520. It will be appreciated, however, that any method of communication between the control device 520 and the data collection station 530 may be used, including RF communication, by way of example only. The HVAC control device 520 includes a microprocessor 565 and a memory 560. The memory 560 can be any kind of memory device but is preferably an EEPROM memory. The HVAC control device 520 further includes an output device, which may include an LED 570, that can be used to flash a signal that the run-test sequence has been initiated.

In the embodiment shown in FIG. 3, the data collection station 530 provides a power source to the HVAC unit 510, typically at 115 VAC, and to the control device 520, typically at 24 VAC, via a power cable 545, although power may be provided by alternate sources. In this embodiment, the data collection station 530 also delivers the control device signals that comprise the run-test initiation code to the HVAC control terminals 550. Based on the pre-programmed run-test sequence stored in the memory 560 and executed by the microprocessor 565, the HVAC control device 520 directs the HVAC unit 510 to perform certain operations for a pre-determined period of time.

Data pertaining to the functions performed is collected by the data collection station 530, such as via the wire bundle 540 and the power cable 545. The data collection station 530 also includes a microprocessor (not shown) to conduct analysis and comparison of the received data versus expected values for the various functions conducted during the run-test. Preferably, the data collection station 530 also includes, or is in communication with, a memory device to which the collected data may be recorded.

The collected data can then be analyzed to determine whether the HVAC unit is performing properly. If not, the collected data is further available to help make a determination of corrective action for proper operation. Although illustrated in FIG. 3 as external the HVAC unit, the microprocessor and memory of the data collection station 530 may be the same microprocessor 565 and memory 560 found in the control device 520. In that case, just the results of the run-test analysis could be transmitted from the control device 520 for determination of any corrective action.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A heating, ventilation and air conditioning (HVAC) control system comprising:
an HVAC unit; and
a control device for controlling operation of the HVAC unit, the control device comprising:
a plurality of terminals configured to receive or transmit control signals for the HVAC unit;
a memory device storing a run-test initiation code and instructions for executing a run-test sequence; and
a microprocessor configured to receive a plurality of control signals corresponding to the run-test initiation code at at least one terminal of the plurality of terminals and further configured to execute the instructions for executing the run-test sequence in response to receiving the plurality of control signals corresponding to the run-test initiation code.

2. The control system of claim 1, wherein the memory device is an EEPROM memory device.

3. The control system of claim 1, wherein the control device further comprises a visual indicator configured to indicate execution of the run-test sequence.

4. The control system of claim 1, wherein the HVAC unit is at least one component selected from the group consisting of a furnace, a heat pump, an air conditioner and an air handler.

5. The control system of claim 1, wherein the run-test initiation code corresponds to a predetermined electrical short in at least one terminal of the plurality of terminals.

6. The control system of claim 1, wherein the instructions for executing a run-test sequence stored by the memory device include instructions for executing at least two different HVAC unit operations.

7. The control system of claim 1, wherein the control device includes at least one terminal connectable to a data collection station during execution of the run-test sequence.

8. A method for controlling an HVAC unit having an HVAC control device comprising:
transmitting control signals to an HVAC control device;
comparing the transmitted control signals to a run-test initiation code stored in a memory of the HVAC control device; and
executing a run-test sequence stored in the memory of the HVAC control device in response to the transmitted control signals matching the run-test initiation code.

9. The method of claim 8, further comprising:
transmitting run-test data to a data collection station as a result of execution of the run-test sequence; and
analyzing the transmitted run-test data.

10. The method of claim 9, wherein the analyzing of the transmitted run-test data comprises comparing the transmitted run-test data to expected results.

11. The method of claim 9, wherein transmitting run-test data to the data collection station comprises transmitting run-test data via at least one wire.

12. The method of claim 8, further comprising:
providing a visual signal indicating that the run-test sequence is being executed.

13. The method of claim 12, wherein providing a visual signal includes illuminating an LED.

14. The method of claim 8, wherein the steps of transmitting control signals and executing the run-test sequence are performed prior to installation of the HVAC unit.

15. The method of claim 8, wherein the steps of transmitting control signals and executing the run-test sequence are performed subsequent to installation of the HVAC unit.

16. The method of claim 8, wherein executing the run test sequence occurs in the absence of a timer external the HVAC unit.

17. The method of claim 8, wherein executing the run test sequence comprises executing at least two different unit operations of the HVAC unit.

18. The method of claim 8, wherein transmitting control signals comprises applying a short to a plurality of thermostat connections provided on the HVAC unit.

19. The method of claim 8, wherein the step of transmitting control signals comprises transmitting control signals from a data collection station.

20. The method of claim 19, wherein step of transmitting control signals from a data collection station comprises transmitting control signals from a data collection station external the HVAC unit.
